(19) United States
(12) Patent Application Publication
(10) Pub. No.: US 2006/0182027 A1
(43) Pub. Date: Aug. 17, 2006

(54) Method and server for controlling data flows in telecommunications network

(75) Inventors: Alberto Conte, Paris (FR); Philippe Dauchy, Paris (FR); Lie Qian, Richardson, TX (US); Yuke Wang, Plano, TX (US); Yiyan Tang, Richardson, TX (US); Anand Krishnamurthy, Richardson, TX (US)

Correspondence Address: SUGHRUE MION, PLLC, 2100 PENNSYLVANIA AVENUE, N.W., SUITE 800, WASHINGTON, DC, 20037, US

(73) Assignee: ALCATEL, Paris (FR)

(21) Appl. No.: 10/562,837

(22) PCT Filed: Jun. 28, 2004
(86) PCT No.: PCT/FR04/01654

§ 371 Date: Dec. 29, 2005

(30) Foreign Application Priority Data
Jul. 1, 2003 (FR) 03/07995

(51) Int. Cl. H04L 12/26; H04J 1/16; H04L 12/56

(52) U.S. Cl. 370/230; 370/252; 370/395.2

(57) ABSTRACT

The invention relates to a method for controlling data traffic in a telecommunications network (150), said control being carried out in terms of a statistic modeling of the traffic transmitted by the network (150) by means of a gaussian distribution of the data flow. According to the invention, one such method is characterized in that a characteristic value of the Gaussian distribution is weighted by means of a parameter ? which varies according to the intensity of the variations or the discontinuity, of the traffic process by said network (150), said weighted value being used to evaluate the traffic in the network.

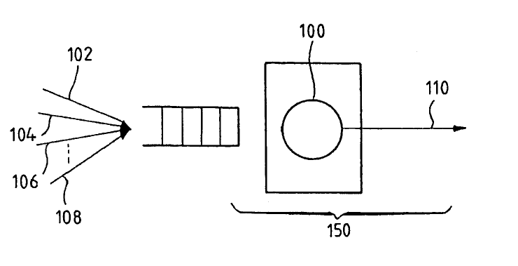

The present invention relates to a method and server for monitoring data streams in a telecommunications network, in particular for admitting new data streams into that network.

A telecommunication network such as the Internet network can transmit data of diverse kinds, and in particular multimedia data coding information such as á conversation, a picture and/or a sequence of pictures.

To this end, that information is coded in a computer language and then transmitted in packets of data to generate a data stream, each data packet of the same data stream having the same label, comprising in particular the addresses in the network of the sender and the receiver of the data stream.

To obtain high quality transmission of the data stream, it is necessary to prevent the network transmitting the stream from being congested, which causes long packet transmission delays, the loss of one or more packets and/or other phenomena degrading the communication quality of the network.

This is why, when a data stream must be admitted into a communication network, a server controlling the quality of service (QoS) determines if admitting the new data stream into the network is acceptable by ensuring that the transmission of the new data stream and of data streams already being transmitted in the network are effected with the required level of quality.

Moreover, the data streams may have varying bit rates, in particular when the data codes audio and/or video information relating to a videoconference, for example. Furthermore, the variation of the bit rate of a stream, i.e. the continuity of that stream, also varies as a function of the nature of the data transmitted by the stream.

For example, when transmitting a telephone conversation, periods of silence generating a low data bit rate alternate with periods of conversation that generate higher data bit rates. Furthermore, the bit rate of the data stream relating to a conversation of this kind varies little. A stream of this kind is then said to have a low discontinuity (or “low burstiness”).

Taking another example, the transmission of a sequence of pictures relating to video, for example, leads to transmission of pictures at a very high bit rate alternating with periods of virtually zero bit rate. In this case, the bit rate of the data stream is said to have a high discontinuity (or “high burstiness”).

As indicated above, when a data stream must be transmitted via a telecommunication network, a server controlling the quality of service of that network must determine if it can transport the new stream whilst assuring the quality of the new stream and that of transmissions already in progress.

While this kind of data stream control proves relatively simple to put into practice if the bit rate of the stream to be admitted is known beforehand, the situation is more complex if the bit rate of the stream varies subsequently to its admission, as in the case of streams of multimedia data, all the more so if the stream has a high burstiness.

Because of this, it is known in the art to use models to determine statistically whether to admit a data stream into the network by considering all the streams of the network concerned, referred to hereinafter as the traffic of the network.

These data traffic models use parameters associated with the traffic, for example a minimum bit rate, a degree of burstiness of the signal and/or an average bit rate, to validate or refuse admission of the new data stream in order to conform to a predetermined compromise between the required quality and the maximum use of the network, i.e. its maximum efficiency.

One prior art model of data traffic in a telecommunication network uses pairs of values consisting of intervals and maximum bit rates permitted during those intervals. This model is referred to hereinafter as the deterministic bounding interval-length dependent (D-BIND) model.

In practice, it is known in the art to use the D-BIND model to characterize video traffic in particular by defining a number p of pairs:
{(Rₖ, Iₖ)|k=1, . . . , p} (1)
where Iₖ is an interval and Rₖ is the maximum data bit rate that the stream concerned can send during the interval Iₖ.

Accordingly, if Aⱼ[t₁, t₂] represents the total number of bits sent by the data stream j between the times t₁ and t₂, then the maximum bit rate Rₖ of data for the stream j is defined as follows:

$${R}_{k} = {max}_{0 \leq t} ( \frac{{A}_{j} [ t , t + {I}_{k} ]}{{I}_{k}} ) .$$

The value of p is normally chosen empirically in the range from 4 to 8, this set of values of Rₖ being used as a parameter of the admission control algorithm, as described, for example, in E. W. Knightly, “H-BIND: A New Approach to Providing Statistical Performance Guarantees to VBR Traffic”, Proceedings of IEEE INFOCOM '96, (San Francisco, Calif.), pp. 1091-1099, March 1996.

One prior art application of the D-BIND model relates to the transmission of video coded in accordance with the Motion Picture Expert Group (MPEG) protocol, the traffic then being characterized by three types of subsets of data called the I, B and P frames that comprise different quantities of data and have a particular order of transmission.

In this case, the MPEG protocol requires that different lengths of the intervals Iₖ are used to characterize an MPEG stream overall.

Data stream admission control using the S-BIND model may be effected by means of an H-BIND algorithm that uses the pairs {(Rₖ, Iₖ) k=1, . . . p} provided by the D-BIND traffic model.

To be more precise, the H-BIND algorithm considers the data stream to have a Gaussian distribution so that the variance and the mean of the distribution may be computed by considering the worst case scenario for each interval Iₖ concerned, i.e. the situation such that that maximum value of the variance in the interval is considered, which lowers traffic forecasting performance.

From this variance and this mean, the algorithm computes the probability of exceeding permitted delay limits in relation to the interval Iₖ to evaluate the maximum probability of exceeding the permitted delay limits for the total stream, i.e. the incoming stream and the stream already being transmitted.

To this end, the H-BIND algorithm divides time into intervals that, in the case of MPEG video, may correspond to the time necessary for transmitting a sub-set of data, that data stream then being modeled by a series of positive real numbers
{Xₜ₁, Xₜ₂, . . . , X_{tN}}
obtained from a function b(t) generated by means of the pairs {(Rₖ, Iₖ)|k=1, . . . , p} supplied by the D-BIND model, described above, in accordance with the following formula:

$$b ( t ) = \frac{{R}_{k} {I}_{k} - {R}_{k - 1} {I}_{k - 1}}{{I}_{k} - {I}_{k - 1}} ( t - {I}_{k} ) + {R}_{k} {I}_{k} , {I}_{k - 1} \leq t \leq {I}_{k}$$

From this function b(t), there are obtained the values of b(t) for each interval considered, which generates the series:
{bₜ₁, bₜ₂, . . . , b_{tN}}.

The method of maximizing the variance of the series of data modeling the bit rates of data in the intervals is of the “all or nothing” type, in which “all” is represented by b₁ which is the value of quantity of data in the smallest sub-set and “nothing” is represented by 0.

The new series {Xₜ₁, Xₜ₂, . . . , X_{tN}} is then of the type
{bₜ₁,0,0,bₜ₁,0,0,0,bₜ₁,0,0,0,bₜ₁,0,0,0 . . .},
the number of zeros between the successive bₜ₁ being obtained from the function b(t).

Once the sequence {Xₜ₁, Xₜ₂, . . . , X_{tN}} has been obtained, the mean and the variance of the bit rates are computed over intervals of length k:

$$μ = ( \frac{1}{N} ) {\sum }_{i = 1}^{N} {X}_{{t}_{1}} , \\ {σ}^{2} ( {t}_{k} ) = ( \frac{1}{N - k} ) {\sum }_{i = 1}^{N - k + 1} {( \frac{{\sum }_{m = 0}^{k - 1} {X}_{{t}_{1} , {t}_{m}} - k μ}{{t}_{k}} )}^{2} \qquad ( 1 )$$

According to the central limit theorem (CLT), multiplexed traffic can be modeled using the H-BIND algorithm by a normal distribution B(tₖ) having the mean value

$${μ}^{⋒} ( {t}_{k} ) = {\sum }_{j} k {μ}_{j}$$

and the variance

$$σ ( {t}_{k} ) = {\sum }_{j} {t}_{k}^{2} {σ}_{j}^{2} ( {t}_{k} ) ,$$

where μⱼ and σⱼ (tₖ) are evaluated for each data stream j. The probability of exceeding the established delay limit dⱼ is:
Prob{delay>dⱼ}=max_{0≦t}_{ₖ}_{≦}_{_{β}}Prob{B(tₖ)−Ctₖ≧Cdⱼ}
in which

$$β = min \{ t > 0 \vert {\sum }_{j} {b}_{j} ( t ) \leq Ct \}$$

is the limit of the busy period bound.

H-BIND modeling is executed for all the current data streams and for the data stream waiting to be authorized to be admitted into the network.

If the probability of exceeding the delay for the limit of the delay dⱼ of the data stream j is lower than the imposed level P₁, the new data stream is authorized to enter the network.

The present invention results from the observation that, by transforming the sequence
{bₜ₁, bₜ₂, . . . , b_{tN}}
into a new sequence
{bₜ₁,0,0,bₜ₁,0,0,0,bₜ₁,0,0,0,bₜ₁,0,0,0 . . . },

as explained above, the data stream is modeled by a sequence of values that is constrained by the function b(t), i.e. with a maximum variance between the sequences that is constrained by b(t).

In other words, the H-BIND algorithm uses the worst case scenario to analyze the network traffic, which lowers the efficiency of use of the network that generates satisfactory results for a data stream having a high burstiness, such as a video stream.

However, if the traffic is of low burstiness, the H-BIND algorithm tends to cause underuse of the network capacity, which represents a major problem in relation to the cost effectiveness of the communication network and a problem in relation to evaluating the burstiness in a network.

The present invention aims to solve this problem. Thus it relates to a method of controlling data traffic in a telecommunications network using a statistical model of the traffic transmitted by the network and a Gaussian distribution of the data bit rate, in which method a value characteristic of said Gaussian distribution is weighted by a parameter varying as a function of the intensity of the variations, also known as the burstiness, of the traffic processed by the network and said weighted value is used to evaluate the traffic in the network, which method is characterized in that the weighting parameter γ is defined by means of an average value λ_{avg} of the data bit rate and a maximum value λₚₑₐₖ of the data bit rate over a given period.

An algorithm using a method conforming to the invention, hereinafter referred to as γH-BIND algorithm, can use this parameter γ to modify the Gaussian modeling of the data traffic as a function of the burstiness of the traffic.

A method conforming to the invention significantly improves the use of network capacity for traffic of low burstiness (‘non-bursty’).

In one embodiment the weighting parameter γ is defined as the ratio of the average value λ_{avg} of the data bit rate to the maximum value λₚₑₐₖ of the data bit rate:

$$γ = \frac{{λ}_{avg}}{{λ}_{peak}}$$

In one embodiment the average value λ_{avg} of the data bit rate is measured over a predetermined period during which the maximum value λₚₑₐₖ of the data bit rate is determined.

In one embodiment the average value μ of the Gaussian distribution is weighted, for example by means of a formula such as:
μ′=(1−γ)(μ−λ_{avg})+λ_{avg}

In one embodiment a model of the data traffic is used involving pairs of values
{(Rₖ, Iₖ)|k=1, . . . , p}
in which Iₖ is a interval, p is a variable generally having a value from 4 to 8 and Rₖ is the maximum data bit rate that a given data stream can send during that interval Iₖ such that, the maximum data bit rate Rₖ for the stream j is defined as follows:

$${R}_{k} = {max}_{0 \leq t} ( \frac{{A}_{j} [ t , t + {I}_{k} ]}{{I}_{k}} )$$

where Aⱼ[t₁, t₂] represents the total number of bits sent by the data stream (j) concerned between the times t₁ and t₂.

In one embodiment a data stream is modeled by a series of positive real numbers
{Xₜ₁, Xₜ₂, . . . , X_{tN}}

obtained from a function b(t) generated by means of pairs of values {(Rₖ, Iₖ)|k=1, . . . p}, for example in accordance with a formula such as:

$$b ( t ) = \frac{{R}_{k} {I}_{k} - {R}_{k - 1} {I}_{k - 1}}{{I}_{k} - {I}_{k - 1}} ( t - {I}_{k} ) + {R}_{k} {I}_{k} , {I}_{k - 1} \leq t \leq {I}_{k}$$

In one embodiment a confidence level ε is defined using a random variable Sₖ specific to the distribution of the data stream bit rate concerned during an interval Iₖ by associating with it a probability density function Sₖ(a) defined as follows:

$${S}_{k} ( a ) = prob ( \frac{{A}_{j} [ t , t + {I}_{k} ]}{{I}_{k}} \leq a ) , ∀ t \geq 0$$

and then defining the value Rₖ for each interval Iₖ as follows:

$${\int }_{0}^{{R}_{k}} {s}_{k} ( t ) ⅆ t = ɛ$$

where 0<ε≦1.

In one embodiment data traffic control is used to decide whether to admit into the network a data stream relating, for example, to multimedia information such as a conversation, a videoconference, a picture and/or a sequence of pictures coded in accordance with the MPEG protocol, for example.

The invention also concerns a device for controlling data traffic in a telecommunications network using a statistical model of the traffic transmitted by the network and a Gaussian distribution of the data bit rate, which device is characterized in that it comprises means for executing a method according to any one of the preceding embodiments to weight a value characteristic of said Gaussian distribution by a parameter γ varying as a function of the intensity of the variations, also known as the burstiness, of the traffic processed by the network and said weighted value is used to evaluate the traffic in the network.

Other features and advantages of the invention will become apparent from the following illustrative and nonlimiting description referring to the appended single figure that is a diagram of a method of controlling the admission of data streams into a communication network.

According to the invention, the algorithm described hereinafter is applied to a method of admitting a data stream considered in the form of a Gaussian distribution based on statistical modeling.

It is therefore necessary to make it clear that the D-BIND model described above uses maximum bit rates to characterize certain intervals. Now in some cases those maximum bit rates are not known, for example if the received stream is processed in real time, which means that this model cannot be used in such cases.

This is why, in accordance with one aspect of the invention that may be used independently of the aspects previously indicated, the D-BIND model is improved by taking into account the lack of knowledge of parameters of the stream concerned.

For this purpose there is defined a random variable Sₖ specific to the distribution of the bit rate of the data stream during an interval Iₖ by associating with it a probability density function sₖ(a) defined as follows:

$${S}_{k} ( a ) = prob ( \frac{{A}_{j} [ t , t + {I}_{k} ]}{{I}_{k}} \leq a ) , ∀ t \geq 0$$

where Aⱼ[t₁, t₂] represents the quantity of data in the stream j during the period [t₁, t₂].

For each interval Iₖ, Rₖ is defined as follows:

$${\int }_{0}^{{R}_{k}} {S}_{k} ( t ) ⅆ t = ɛ$$

where 0<ε≦1.

When ε=1, Rₖ has the same value as with the D-BIND model. If ε decreases, Rₖ decreases, which increases network use efficiency.

Hereinafter, ε is called the confidence level of the S-BIND model.

In the S-BIND model, each data stream is characterized by sets of three values {ε, (Rₖ, Iₖ)|k=1, . . . , p} or by sets of two values {(Rₖ, Iₖ, εₖ)|k=1, . . . , p} according to whether the confidence level ε may vary or is fixed for the various intervals Iₖ.

Once the S-BIND parameters have been fixed, the server controlling the quality of service (QoS) can perform statistical admission control using a statistical control algorithm such as the H-BIND algorithm.

In this embodiment, the server uses the γH-BIND admission control algorithm of the invention, which defines a parameter of the burstiness of a data stream γ as follows:

$$γ = \frac{{λ}_{avg}}{{λ}_{peak}}$$

where λ_{avg} is an average value of the bit rate of the data stream, either measured over a given period or estimated in advance, and λₚₑₐₖ is the maximum value of the stream bit rate in the network.

In this embodiment, the parameter γ is used to weight the average μ of the data stream calculated from equation (2) to obtain a new value μ′ as follows:
μ′=(1−γ)(μ−λ_{avg})+λ_{avg}

Weighting μ produces a series of values {Xₜ₁, Xₜ₂, . . . , X_{tN}} by means of the γH-BIND algorithm offering improved performance compared to the series of values {Xₜ₁, Xₜ₂, . . . , X_{tN}} obtained by means of the H-BIND algorithm, in particular for non-bursty traffic, as shown hereinafter by the results of experiments set out in the appended tables 1 and 2.

In fact, if the burstiness of the traffic tends to increase, then γ tends toward 0 and the weighted mean value μ′ tends toward μ.

In contrast, if the traffic is non-bursty, then γ tends to be close to 1 and the weighted value μ′ is close to the data stream average value λ_{avg}.

To summarize, the new stream admission control algorithm γH-BIND therefore has the advantage over the prior art, and in particular over the H-BIND algorithm, of considering the burstiness of the data stream, enabling better use of network resources, in particular in the context of non-bursty data streams.

Experiments were conducted at a node 100 (see appended figure) of a telecommunication network having a plurality of stream inputs 102, 104, 106 and 108 and a single output 110 of capacity C=45 Mbps.

It should be pointed out that, to simplify bit rate estimation, no account was taken of communication between the quality controller and the node 100.

In a first stage of the experiment, the results for which are set out in table 1, the node 100 received data traffic comprising streams of two kinds, namely:

non-bursty data streams, for example comprising information relating to a telephone call, and

bursty data streams, for example comprising information relating to a video sequence.

All the streams had the same delay limit d, meaning that this data packet transmission delay had to be complied with for transmission to take place.

The two types of data stream had the following characteristics:

| | |
|---|---|
| Non-bursty traffic | Bursty traffic |

| | | | | |
|---|---|---|---|---|
| Average OFF time | 1.587 | s | 0.9 | s |
| Average ON time | 1.004 | s | 0.1 | s |
| Constant bit rate | 64 | kbps | 258 | kbps |
| during ON phase | | | | |

In the above table, “Average off time” (respectively “Average on time”) is the time for which no data is transmitted (respectively data is transmitted).

In a second stage of the experiment, the results for which are set out in table 2, the node 100 received only bursty data traffic. The data stream contained information relating to a video sequence, for example.

During the above simulations, the efficiency of the network 150 using the H-BIND and γH-BIND access control algorithms was tested with various delay limits d and various confidence levels ε, as indicated in the appended tables 1 and 2.

Thus the delay limits d varied from 1 ms to 40 ms and the confidence levels ε varied from 99% to 77%.

Moreover, the imposed quality rule was as follows:

Rate of exceeding maximum delay <=1%

Finally, it should be indicated that tables 1 and 2 represent measured total bit rate and percentage of use of the network in the form “bit rate/% use”.

It was found (see table 1), that for non-bursty traffic a γH-BIND algorithm of the invention obtained a network usage efficiency from 3% to 4% greater than that of the H-BIND algorithm, independently of the value of the parameter ε.

Furthermore, for bursty traffic, for example traffic comprising a video data stream, a γH-BIND algorithm conforming to the invention again yielded an efficiency higher than the efficiency obtained by the H-BIND algorithm, independently of the value of the parameter ε.

Moreover, in this second case, it should be pointed out that the maximum efficiency of the network (“trace” value).

Finally, it should be pointed out that tables 1 and 2 indicate average and extreme values λₚₑₐₖ of the bit rate of the data stream measured in each case over a given period or estimated in advance.

The present invention lends itself to numerous variants. Thus the invention may be applied to a sub-network, or domain, controlled by a control server determining whether to admit a data stream into that domain.

Furthermore, it is clear that other variables characteristic of the Gaussian distribution used to model the data traffic may be weighted by means of a variable that is a function of the burstiness of the traffic, for example the variance of the distribution.

TABLE 1

| | | Delay | | | | |
|---|---|---|---|---|---|---|
| | | 1 ms | 5 ms | 10 ms | 20 ms | 40 ms |
| Trace | | 1668/92% | 1700/94% | 1715/95% | 1732/96% | 1753/97% |
| Peak Value | | 703/39% | 703/39% | 703/39% | 703/39% | 703/39% |
| Average Value | | 1814/100% | 1814/100% | 1814/100% | 1814/100% | 1814/100% |
| HBind | ε = 99% | 1503/83% | 1569/87% | 1572/87% | 1575/87% | 1580/88% |
| | ε = 95% | 1512/84% | 1588/88% | 1590/88% | 1593/88% | 1595/88% |
| | ε = 90% | 1521/84% | 1601/89% | 1603/89% | 1605/89% | 1606/89% |
| | ε = 80% | 1532/85% | 1618/90% | 1619/90% | 1619/90% | 1620/90% |
| | ε = 70% | 1548/86% | 1628/90% | 1628/90% | 1629/90% | 1629/90% |
| γHBind | ε = 99% | 1573/87% | 1644/91% | 1647/91% | 1651/91% | 1656/92% |
| | ε = 95% | 1579/87% | 1660/92% | 1663/92% | 1666/92% | 1669/92% |
| | ε = 90% | 1585/88% | 1671/93% | 1673/93% | 1675/93% | 1676/93% |
| | ε = 80% | 1593/88% | 1683/93% | 1684/93% | 1684/93% | 1684/93% |
| | ε = 70% | 1606/89% | 1690/94% | 1690/94% | 1690/94% | 1690/94% |

TABLE 2

| | | Delay | | | | |
|---|---|---|---|---|---|---|
| | | 1 ms | 5 ms | 10 ms | 20 ms | 40 ms |
| Trace | | 1085/62% | 1120/64% | 1147/66% | 1170/67% | 1200/69% |
| Peak Value | | 170/10% | 170/10% | 170/10% | 170/10% | 170/10% |
| Average Value | | 1744/100% | 1744/100% | 1744/100% | 1744/100% | 1744/100% |
| HBind | ε = 99% | 868/51% | 943/56% | 986/58% | 999/59% | 1005/59% |
| | ε = 95% | 954/56% | 1036/61% | 1106/65% | 1199/66% | 1125/66% |
| | ε = 90% | 1068/63% | 1153/68% | 1156/68% | 1159/68% | 1163/69% |
| | ε = 80% | 1442/85% | 1541/91% | 1541/91% | 1541/91% | 1541/91% |
| | ε = 70% | 1541/91% | 1584/93% | 1614/95% | 1639/97% | 1659/98% |
| γHBind | ε = 99% | 901/53% | 978/58% | 1025/60% | 1040/61% | 1047/62% |
| | ε = 95% | 983/58% | 1068/63% | 1142/67% | 1158/68% | 1164/69% |
| | ε = 90% | 1101/65% | 1190/70% | 1194/70% | 1197/71% | 1201/71% |
| | ε = 80% | 1465/86% | 1541/91% | 1541/91% | 1541/91% | 1541/91% |
| | ε = 70% | 1541/91% | 1590/94% | 1615/95% | 1642/97% | 1663/98% |

1. Method of controlling data traffic in a telecommunications network (150) using a statistical model (D-BIND, S-BIND) of the traffic transmitted by the network (150) and a Gaussian distribution of the data bit rate, in which method a value (μ, σ) characteristic of said Gaussian distribution is weighted by a parameter y varying as a function of the intensity of the variations, also known as the burstiness, of the traffic processed by the network (150) and said weighted value (μ′, σ) is used to evaluate the traffic in the network, which method is characterized in that the weighting parameter γ is defined by means of an average value λ_{avg} of the data bit rate and a maximum value λₚₑₐₖ of the data bit rate over a given period.

2. Method according to claim 1 characterized in that the weighting parameter γ is defined as the ratio of the average value λ_{avg} of the data bit rate to the maximum value λₚₑₐₖ of the data bit rate:
$$γ = \frac{{γ}_{avg}}{{γ}_{peak}}$$

3. Method according to claim 1 characterized in that the average value λ_{avg} of the data bit rate is measured over a predetermined period during which the maximum value λₚₑₐₖ of the data bit rate is determined.

4. Method according to claim 2 or characterized in that the average value μ of the Gaussian distribution is weighted, for example by means of a formula such as:
μ′=(1−γ)(μ−λ_{avg})+λ_{avg}

5. Method according to claim 1 characterized in that a model of the data traffic is used involving pairs of values
{(Rₖ, Iₖ)|k=1, . . . , p}
in which Iₖ is a interval, p is a variable generally having a value from 4 to 8 and Rₖ is the maximum data bit rate that a given data stream can send during that interval Iₖ such that, the maximum data bit rate Rₖ for the stream j is defined as follows:
$${R}_{k} = {max}_{0 \leq t} ( \frac{{A}_{j} [ t , t + {I}_{k} ]}{{I}_{k}} )$$
where Aⱼ[t₁, t₂] represents the total number of bits sent by the data stream (j) concerned between the times t₁ and t₂.

6. Method according to claim 5 characterized in that a data stream is modeled by a series of positive real numbers
{Xₜ₁, Xₜ₂, . . . , X_{tN}}
obtained from a function b(t) generated by means of pairs of values {(Rₖ, Iₖ)|k=1, . . . p}, for example in accordance with a formula such as:
$$b ( t ) = \frac{{R}_{k} {I}_{k} - {R}_{k - 1} {I}_{k - 1}}{{I}_{k} - {I}_{k - 1}} ( t - {I}_{k} ) + {R}_{k} {I}_{k} , {I}_{k - 1} \leq t \leq {I}_{k}$$

7. Method according to claim 6, characterized in that a confidence level ε is defined using a random variable Sₖ specific to the distribution of the data stream bit rate concerned during an interval Iₖ by associating with it a probability density function sₖ(a) defined as follows:
$${S}_{k} ( a ) = prob ( \frac{{A}_{j} [ t , t + {I}_{k} ]}{{I}_{k}} \leq a ) , ∀ t \geq 0$$
and then defining the value Rₖ for each interval Iₖ as follows:
$${\int }_{0}^{{R}_{k}} {S}_{k} ( t ) ⅆ t = ɛ$$
where 0<ε≦1.

8. Method according to claim 1 characterized in that data traffic control is used to decide whether to admit into the network a data stream relating, for example, to multimedia information such as a conversation, a videoconference, a picture and/or a sequence of pictures coded in accordance with the MPEG protocol, for example.

9. Device for controlling data traffic in a telecommunications network (150) using a statistical model (D-BIND, S-BIND) of the traffic transmitted by the network (150) and a Gaussian distribution of the data bit rate, which device is characterized in that it comprises means for executing a method according to any one of the preceding claims to weight a value (μ, σ) characteristic of said Gaussian distribution by a parameter γ varying as a function of the intensity of the variations, also known as the burstiness, of the traffic processed by the network (150) and said weighted value (μ′, σ) is used to evaluate the traffic in the network.
